(19) United States
(12) Patent Application Publication
(10) Pub. No.: US 2023/0169249 A1
(43) Pub. Date: Jun. 1, 2023

(54) CIRCUITS AND TECHNIQUES FOR MODELING REMAINING LIFE OF SEMICONDUCTOR CIRCUITS

(71) Applicant: Infineon Technologies AG, Neubiberg (GE)

(72) Inventors: Thomas Zettler, Hoehenkirchen-Siegertsbrunn (DE); Rafael Zalman, Markt Schwaben (DE); Georg Georgakos, Erding (DE); Dirk Hammerschmidt, Villach (AT); Ludwig Rossmeier, Dorfen (DE); Bernhard Gstoettenbauer, Engerwitzdorf (AT); Veit Kleeberger, Munich (DE)

(21) Appl. No.: 17/457,183

(22) Filed: Dec. 1, 2021

(51) Int. Cl. G06F 30/3308

(52) U.S. Cl. CPC G06F 30/3308

(57) ABSTRACT

In some examples, a method comprises performing a circuit function via a circuit; and estimating a remaining life of the circuit. Moreover, estimating the remaining life of the circuit may include measuring one or more circuit parameters over a period of time during operation of the circuit, and estimating the remaining life of the circuit based on the one or more measured circuit parameters over the period of time during operation of the circuit.

### TECHNICAL FIELD

This disclosure relates to semiconductor circuits, and more specifically, circuits and technique for assessing and managing semiconductor circuits during use.

### BACKGROUND

Semiconductor circuits are used in a wide variety of circuit applications in order to perform any of a variety of circuit functions. Unfortunately, semiconductor circuits can degrade over time. For example, aging, environmental exposure, stress, or other conditions can lead to semiconductor degradation and possibly circuit failure, which is undesirable. The amount of stress conditions applied to semiconductor circuits strongly varies from case to case. As a result, the actual operational lifetime of a semiconductor circuit may be unpredictable.

In many situations, semiconductor circuits may be designed to tolerate a worst-case mission profile during the lifetime of a system into which the circuit will be installed (e.g., a vehicle). Only a small percentage of circuits will actually be exposed to the worst-case mission profile. Consequently, many semiconductor circuits are overdesigned with respect to their actual mission profile, which can increase production costs associated with the semiconductor circuits.

### SUMMARY

This disclosure describes techniques and circuits for assessing aging effects in circuits, modeling a remaining life of a circuit, and possibly predicting future problems in circuits (due to aging) before the problems occur. The described circuits and techniques may be used with a wide variety of circuits designed for a wide variety of different circuit functions. The techniques and circuits described in this disclosure may provide predictive alerts (i.e., predictive faults) that are based on the modeling in order predict circuit problems before the problems actually occur in functional circuits. In this way, system maintenance can be identified and performed (e.g., to replace functional circuits within a larger system) before the functional circuits reach an end-of-life and before exhibiting actual problems or failure. The circuits and techniques may promote safety and reliability in devices or systems, such as in a vehicle or a similar setting.

In one example, a circuit may comprise a function unit configured to perform a circuit function, and a lifetime model unit configured to estimate a remaining life of the circuit. The lifetime model unit may be configured to measure one or more circuit parameters over a period of time during operation of the circuit, and estimate the remaining life of the circuit based on the one or more measured circuit parameters over the period of time during operation of the circuit.

In another example, this disclosure describes a method that comprises performing a circuit function via a circuit, and estimating a remaining life of the circuit. In this case, estimating the remaining life of the circuit may include measuring one or more circuit parameters over a period of time during operation of the circuit, and estimating the remaining life of the circuit based on the one or more measured circuit parameters over the period of time during operation of the circuit.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram of a circuit according to an example of this disclosure.

FIG. 2 is a block diagram of one example of a circuit lifetime model unit.

FIG. 3 is a graph showing an example of temperature measurements that may form a measured profile of a circuit.

FIG. 4 is a graph showing extrapolation of the temperature measurements of FIG. 3 over a larger period of time to create a predicted profile of a circuit.

FIG. 5 is another block diagram showing another example circuit that includes a circuit function unit and a circuit lifetime model unit.

FIG. 6 is a graph showing an example of count values of circuit events that may form a measured profile of a circuit.

FIG. 7 is a graph showing extrapolation of count values of FIG. 6 over a larger period of time to create a predicted profile of a circuit.

FIG. 8 is a flow diagram showing an example technique of this disclosure.

FIG. 9 is a graph showing typical circuit failure rates as a function of time.

FIG. 10 is a graph showing extrapolation of the temperature measurements and non-operating time to create a predicted profile of a circuit that accounts for operating time and non-operating time of the circuit.

FIG. 11 is a basic graph showing an example relationship between base failure rate (BFR) of a circuit and probabilistic metric for hardware failures (PMHF), e.g., in accordance with the International Organization for Standardization (ISO) standard 26262 related to functional safety in road vehicles.

### DETAILED DESCRIPTION

This disclosure describes techniques and circuits for assessing aging effects in circuits, modeling a remaining life of a circuit, and possibly predicting future problems in circuits (due to aging) before the problems occur. The described circuits and techniques may be used with a wide variety of circuits designed for a wide variety of different circuit functions. The circuits and techniques may promote safety in devices or systems, such as in a vehicle or a similar setting. Modern vehicles and other modern devices or systems may include a large number of functional circuits and monitoring the health or operational safety of any of a wide variety of functional circuits is desirable to promote safety and reliability vehicles or other devices or systems. The techniques of this disclosure may use end-of-life modeling that is based on measured circuit parameters over a period of time (e.g., over the life of the circuit or a portion of the life of the circuit). The modeling, in some cases, may be based on an extrapolation of the measured circuit parameters over the period of time (e.g., extrapolated over a second period of time).

In some examples, the techniques and circuits described in this disclosure may provide predictive alerts (i.e., predictive faults) that are based on the modeling in order predict circuit problems due to end-of-life before such problems actually occur in functional circuits. In this way, system maintenance can be identified and performed (e.g., to replace a circuit in the system) before the circuit reaches its end-of-life and exhibits actual problems or failure. In some cases, the techniques and circuits of this disclosure for modeling the life of a circuit may be used in combination with other techniques that identify actual existing circuit problems that may currently exist.

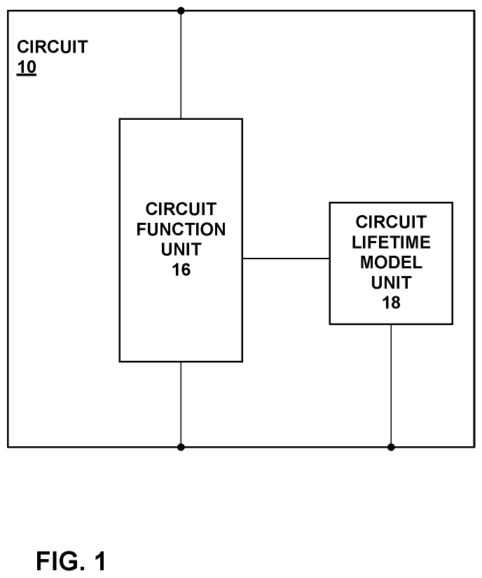

FIG. 1 is a block diagram showing a circuit 10 according to an example of this disclosure. Circuit 10 comprises a circuit function unit 16 configured to perform a circuit function, and a circuit lifetime model unit 18 configured to estimate a remaining life of circuit 10. In particular, as described in greater detail below, lifetime model unit 18 may be configured to measure one or more circuit parameters of circuit function unit 16 over a period of time during operation of circuit 10 and estimate the remaining life of circuit 10 based on the one or more measured circuit parameters of circuit function unit 16 over the period of time during operation of the circuit. In some examples, lifetime model unit 18 may model the circuit life by extrapolating the measured circuit parameters over larger period of time than the period of time associated with the measurements.

Circuit function unit 16 may be configured to perform one or more circuit functions. For example, circuit function unit 16 may comprise a driver circuit configured to drive a load. In another example, circuit function unit 16 may comprise a logic circuit configured to perform one or more logic functions. In another example, circuit function unit 16 may comprise a motor driver configured to drive a motor such as a multi-phase motor. In another example, circuit function unit 16 may comprise an oscillator circuit configured to generate an oscillating signal. In another example, circuit function unit 16 may comprise a level shifter circuit configured to shift or change the voltage level of a signal. In another example, circuit function unit 16 may comprise a phase shift circuit configured to shift the phase of a signal. In another example, circuit function unit 16 may comprise a phase locked loop circuit configured to provide an output signal having a phase that is based on the input signal. In another example, circuit function unit 16 may comprise an analog-to-digital converter (ADC) circuit configured to convert an analog signal to a digital signal. In another example, circuit function unit 16 may comprise a digital-to-analog converter (DAC) circuit configured to convert a digital signal to an analog signal. In another example, circuit function unit 16 may comprise an arithmetic logic unit (ALU) configured to perform an arithmetic function. In still other examples, circuit function unit 16 may comprise a processor, a microcontroller, a digital signal processor (DSP), a communication interface circuit such as a serial peripheral interface (SPI) or another type of communication interface circuit, a digital logic circuit, a state machine, a signal processing circuit, a control circuit, an analog function circuit, a memory circuit, a sensor, a sensor combined with at least a part of its readout and signal processing circuit, a communication interface or any other circuit configured to perform one or more circuit functions.

In some examples, circuit lifetime model unit 18 is configured to measure the one or more circuit parameters of circuit function unit 16 over a first period of time during operation of circuit 10 and extrapolate the measured one or more one or more circuit parameters over a second period of time that is different than the first period of time. Based on the extrapolation of the measured one or more one or more circuit parameters over the second period of time, circuit lifetime model unit 18 may estimate the remaining life of circuit 10.

In some cases, circuit lifetime model unit 18 may be configured to perform one or more actions that are based on the estimation of the remaining life. For example, lifetime model unit 18 may be configured to output an alert in response to identifying that the estimate of the remaining life is less than a threshold, e.g., in which case a larger system may act on the alert to schedule, suggest, or require maintenance on circuit 10. Alternatively or additionally, lifetime model unit 18 may be configured to disable at least a portion of circuit 10 in response to identifying that the estimate of the remaining life is less than a threshold. Moreover, in some cases, lifetime model unit 18 may be configured to disable at least a portion of a larger system associated with circuit 10 in response to identifying that the estimate of the remaining life is less than a threshold.

Several examples of different measured circuit parameters are discussed herein to facilitate the end-of-life modeling. In some examples, the one or more measured circuit parameters comprise temperature measurements. In some examples, the one or more measured circuit parameters comprise activity metric measurements. In some examples, activity metric measurements may comprise one or more counts of circuit activity. In some examples, the one or more measured circuit parameters comprise frequency measurements. In some examples, a combination of different measured parameters may be used, such as temperature measurements and activity measurements, or temperature measurements and frequency measurements, or activity measurements and frequency measurements. In some examples, the one or more measured circuit parameters may comprise temperature measurements, activity metric measurements, and frequency measurements. The specific types of measurements used for end-of-life modeling may, in some examples, depend on the type of function or functions performed by circuit function unit 16.

In some examples, the period of time associated with the measurements of circuit parameters may comprise an entire functional life of the circuit. In some examples, the measurements over the life of the circuit can be extrapolated over a longer time period than the circuit life. The measured circuit parameters over the first period of time may provide an accurate prediction of likely future circuit operations (i.e., probable future measurements that are extrapolated as a prediction based on the actual past measurements of circuit parameters. In various examples, the period of time associated with the measurements of circuit parameters may comprise an entire functional life of the circuit, a portion of the life of circuit 10, or possibly a sliding window of time associated with circuit operation in the field.

In some examples, lifetime model unit 18 may comprise a separate circuit relative to circuit function unit 16. However, in some examples, lifetime model unit 18 may leverage existing parts of circuit function unit 16 when those existing parts are not in use for performing the circuit function. Accordingly, in some examples, lifetime model unit 18 may comprise at least a portion of circuit function unit 16, in which case, lifetime model unit 18 may be configured to estimate the remaining life during a period of time when circuit function unit 16 is not actually performing the circuit function.

In some examples, the one or more measurements of circuit parameters may take place at a plurality of different locations within or around circuit function unit 16. In other words, temperature measurements, activity measurements, activity counts of circuit events, or frequency measurements or counts may occur at a plurality of different locations within or around circuit function unit 16, which may help to improve the modeling that is based on extrapolation of measured parameters or counted events. Thus, in some examples, lifetime model unit 18 may be configured to measure the one or more circuit parameters in a plurality of different circuit locations within or around circuit function unit 16 over a first period of time and extrapolate the measured one or more one or more circuit parameters in the different circuit locations over a second period of time. In this case, lifetime model unit 18 may estimate the remaining life of the circuit based on the extrapolation of the measured one or more one or more circuit parameters in the different circuit locations.

In order to achieve an integrated circuit with integrated safety monitoring features according to this disclosure, in some examples, circuit 10 of FIG. 1 may be housed within a molding compound. In other words, circuit function unit 16 and circuit lifetime model unit 18 may collectively reside within a molding compound of a circuit package. By implementing circuit function unit 16 and circuit lifetime model unit 18 together within a molding compound of a circuit package, a self-contained functional circuit with integrated lifetime modeling functionality can be achieved.

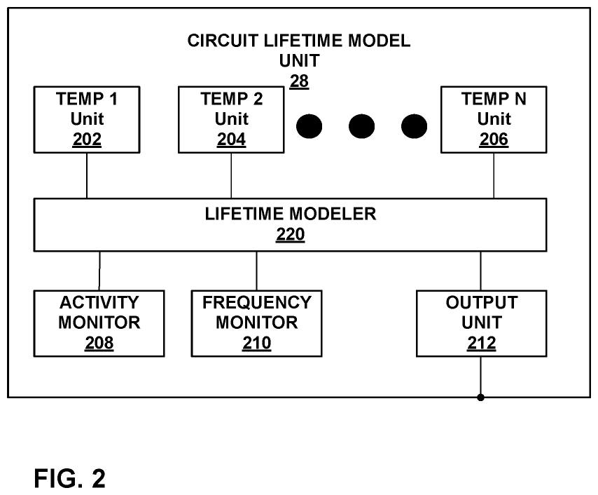

FIG. 2 is a block diagram of one example of a circuit lifetime model unit 28. In this example, circuit lifetime model unit 28 includes several different measurement units that make local measurements associated with a circuit function unit (not shown in FIG. 2). The measurement units, for example, may include one or more temperature units 202, 204, 206, one or more activity monitors 208, and one or more frequency monitors 210. A lifetime modeler 220 may receive the measurements, generate an actual profile of an associated circuit function unit (not shown in FIG. 2) based on the measurements, and generate a predictive profile based on an extrapolation of the measurements. Based on the predictive profile generated by lifetime modeler 220, an output unit 212 may be configured to output one or more messages or alerts to a larger system, e.g., to estimate a remaining life of the circuit, to provide metrics based on the predictive profile, to identify a base failure rate (BFR) of the circuit based on the predictive profile, or to output other faults, alerts, warnings, or metrics that are based on the predictive profile. FIG. 2 is merely one example, and specific types of measurements used for end-of-life modeling may vary in different situations, and in some examples, may depend on the type of function or functions performed by circuit function unit 16.

In the example shown in FIG. 2, circuit lifetime model unit 28 includes a plurality of temperature units 202, 204, 206, which may be positioned at different desirable locations relative to a functional circuit unit (not shown in FIG. 2). One or more activity monitors 208 may be configured to monitor circuit activity or to count instances of circuit events (e.g., output events, voltage events, current events, or other measured events that satisfy a threshold so as to qualify as an event). One or more frequency monitors 210 may also be used as a measurement unit of circuit lifetime model unit 28, e.g., to measure a frequency, such as a clock frequency, a ring oscillator frequency, a switching frequency, or another frequency associated with circuit operation of a functional circuit.

With the example shown in FIG. 2 it may be desirable to implement all of the components shown in FIG. 2 within the same molding compound of a circuit package. However, in other examples, temperature units 202, 204, 206, activity monitor 208 and/or frequency monitor 210 could be implemented in separate circuit packages relative to lifetime modeler 220.

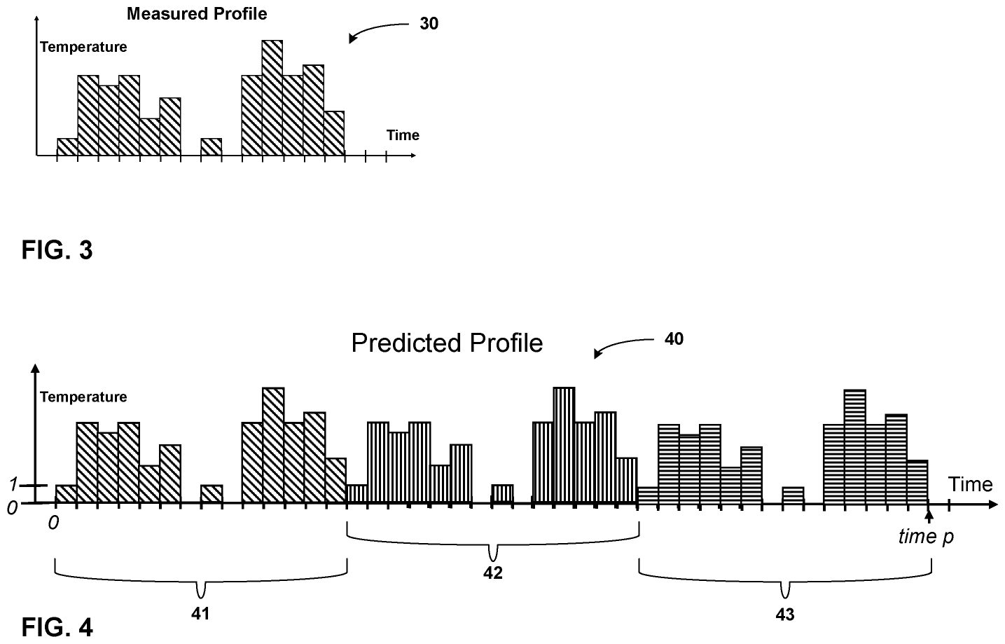

FIG. 3 is a graph showing an example of temperature measurements that may form a measured profile of a circuit. As shown in FIG. 3, a plurality of periodic temperature measurements are made over a first period of time to define a measured profile 30 associated with a functional circuit. Although FIG. 3 is simplified to show only a few measurements, the number of measurements used to define the measured profile may be much more extensive in some examples and may possibly include measurements at intervals over the entire life of a circuit. Indeed, in some examples, the period of time associated with a measured profile for a functional circuit (e.g., a measured profile similar to profile 30 of FIG. 3) may comprise the entire functional life of a circuit.

FIG. 4 is a graph showing extrapolation of the temperature measurements of FIG. 3 over a larger period of time than that associated with measured profile 30, in order to create a predicted parameter profile 40 of a circuit. The measured profile 30 shown in FIG. 3, for example, may correspond to a first portion 41 of the predicted parameter profile 40 shown in FIG. 4. Moreover, the measured profile 30 shown in FIG. 3 may be extrapolated to define a second portion 42 of the predicted parameter profile 40 shown in FIG. 4 and a third portion 43 of the predicted parameter profile 40 shown in FIG. 4. The amount of extrapolation may vary in different situations. In some examples, the amount of extrapolation done to define the predicted parameter profile 40 based on the measured profile 30 may depend on the amount of data in the measured profile 30, an expected life of the circuit under fixed conditions, or other factors.

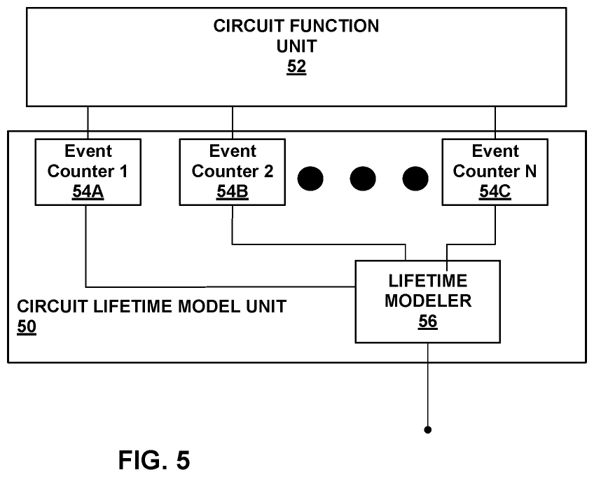

FIG. 5 is another block diagram showing another example circuit that includes a circuit function unit 52 and a circuit lifetime model unit 50. Like circuit function unit 16 in FIG. 1, circuit function unit 52 of FIG. 5 may comprise a driver circuit, a logic circuit, a motor driver, an oscillator circuit, a level shifter circuit, a phase shift circuit, a phase locked loop circuit, an ADC circuit, a DAC circuit, an ALU, a processor, a microcontroller, a DSP, a communication interface circuit such as an SPI or another type of communication interface circuit, a digital logic circuit, a state machine, a signal processing circuit, a control circuit, an analog function circuit, a memory circuit, or any other circuit configured to perform one or more circuit functions.

Circuit lifetime model unit 50 may be configured to estimate a remaining life of circuit function unit 52. In particular, lifetime model unit 50 may be configured to measure one or more circuit events associated with circuit function unit 52 over a period of time during operation of circuit function unit 52 and estimate the remaining life of circuit function unit 52 based on the one or more measured circuit parameters over the period of time during operation of the circuit. For example, a lifetime modeler 56 may be configured to model the circuit life of circuit function unit 52 by extrapolating the measured circuit parameters over larger period of time than the period of time associated with the counted events.

Any number (N) of event counters 54A, 54A, 54C may be used, where N is any positive integer. In some examples, different event counters 54A, 54A, 54C are associated with different circuit nodes that define operational values of circuit function unit 52 (e.g., voltages, currents, or other values within circuit function unit 52). In some examples, each event counter 54A, 54A, 54C includes a comparator connected to a measurable circuit node within circuit function unit 52. The comparator of each event counter 54A, 54A, 54C may be configured to compare values at measurable circuit nodes within circuit function unit 52 to one or more thresholds. If the measured values satisfy the one or more thresholds, a given event counter 54A, 54A, 54C may record a count for that event. Each event counter 54A, 54A, 54C may include a storage device (e.g., a flip-flop) for storing an accumulated count of events for each event counter 54A, 54A, 54C. Flip-flops for each event counter 54A, 54A, 54C may operate according to a counter clock that clocks all counters 54A, 54A, 54C at a same clocking frequency for periodic readout by lifetime modeler 56. Lifetime modeler 56 may be configured to model the circuit life of circuit function unit 52 by extrapolating the measured events (e.g., extrapolating the counts of events) over larger period of time than the period of time associated with the counted events that have occurred.

In order to achieve an integrated circuit with integrated safety monitoring features according to this disclosure, in some examples, the circuit shown in FIG. 5 may be housed within a molding compound. In other words, circuit function unit 52 and circuit lifetime model unit 50 may collectively reside within a molding compound of a circuit package. By implementing circuit function unit 52 and circuit lifetime model unit 50 together within a molding compound of a circuit package, a self-contained functional circuit with integrated lifetime modeling functionality can be achieved.

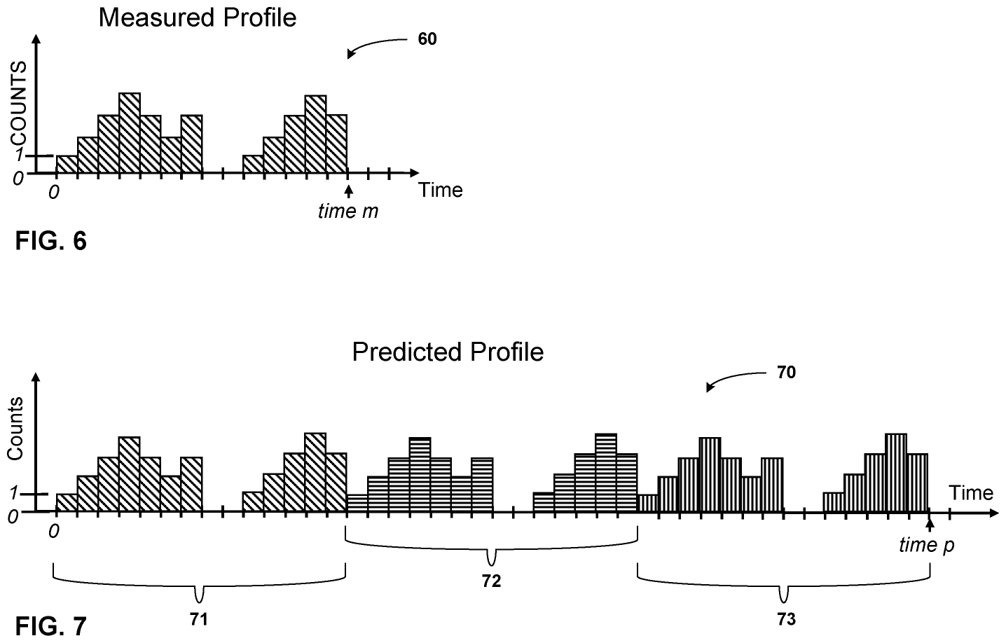

FIG. 6 is a graph showing an example of count values that may form a measured profile of a circuit. As shown in FIG. 6, a total number of events are counted by one or more event counters over a first period of time to define a measured profile 60 associated with a functional circuit. Although FIG. 6 is simplified to show only a few instances of time with different count values, the number of time instances and the number of counts used to define the measured profile may be much more extensive in some examples. The period of time associated with a measured profile 60 for a functional circuit (e.g., a measured profile similar to profile 60 of FIG. 6), in some examples, may comprise the entire life of a circuit.

FIG. 7 is a graph showing extrapolation of the counts (which may be recorded by event counters 54A, 54A, 54C of FIG. 5). Like the temperature measurement example of FIG. 4, in FIG. 7, the extrapolation of counts is over a larger period of time than the period of time associated with creating a measured profile 60. The measured profile 60 shown in FIG. 6, for example, may correspond to a first portion 71 of the predicted parameter profile 70 shown in FIG. 7. Moreover, the measured profile 60 shown in FIG. 6 may be extrapolated to define a second portion 72 of the predicted parameter profile 70 shown in FIG. 6 and a third portion 73 of the predicted parameter profile 70 shown in FIG. 6. As with other examples, the amount of extrapolation may vary in different situations. In some examples, the amount of extrapolation done to define the predicted parameter profile 70 based on the measured profile 60 may depend on the amount of data in the measured profile 60, an expected life of the circuit under fixed conditions, or other factors.

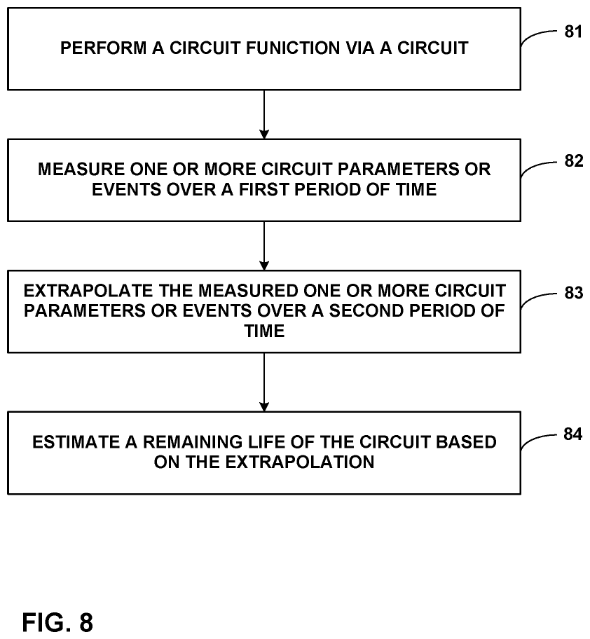

FIG. 8 is a flow diagram showing an example technique of this disclosure. FIG. 8 will be described from the perspective of circuit 10 of FIG. 1, although other circuits may perform the method. As shown in FIG. 8, a circuit function unit 16 performs a circuit function (81). A circuit lifetime model unit 18 estimates a remaining life of circuit 10 according to the additional steps shown in FIG. 8. In particular, in the example shown in FIG. 8, circuit lifetime model unit 18 may measure one or more circuit parameters or events over a first period of time (82), extrapolate the measured one or more circuit parameters or events over a second period of time (83), and estimate a remaining life of the circuit based on the extrapolation of the one or more measured circuit parameters.

In some examples, estimating the remaining life includes calculating a base failure rate, which is discussed in more detail below. Also, in some cases, estimating the remaining life further includes performing a so-called failure mode effect and diagnostic analysis (FMEDA) calculation. An FMEDA calculation may refer to a calculation performed according to the International Organization for Standardization (ISO) standard 26262 related to functional safety in road vehicles. The FMEDA calculation may also be referred to as a quantitative failure mode effect analysis (FMEA) calculation in the ISO standard 26262. In some examples and as explained in more detail below, calculating a base failure rate and performing a FMEDA calculation, for example, may comprise processes defined according to the ISO standard 26262.

In different examples, the one or more measured circuit parameters comprise one or more measurements selected from a group consisting of: temperature measurements, activity metric measurements. one or more counts of a measured circuit activity, and/or frequency measurements. As mentioned above, in some cases, circuit lifetime model unit 18 may be further configured to output an alert in response to identifying that the estimate of the remaining life is less than a threshold, or to disable at least a portion of circuit 10 (or to disable one or more other components of a larger system) in response to identifying that the estimate of the remaining life of circuit 10 is less than a threshold.

In general, semiconductor components (e.g., circuits and devices) are subject to different kinds of wear out due to usage. Wear out can lead to loss of functions or properties which may be required, possibly for safety applications. This is not necessarily a problem, however, if the potential loss of function can be determined in advance, before the loss occurs. In some examples, the techniques of this disclosure can facilitate component or circuit replacement, before loss of function occurs, for circuits that are determined to be near an end of life (and thus likely to be faulty soon).

One goal of this disclosure is to provide solutions for determining or predicting the future loss of function of a component or circuit. In some examples, “Loss of function” may be defined as violation of a certain criterion that are fulfilled before loss of function and not fulfilled after such loss of function. The criterion can be the usable lifetime with respect to increase of reliability failure rate (e.g., an end of flat region in bathtub curve similar to that shown in FIG. 7). The criterion can be also excessive random hardware failure rates or metrics compared to targets defined in the ISO standard 26262 related to functional safety in road vehicles. Other types of criterions are also possible also.

In some examples, the techniques of this disclosure may be realized with merely one sensor or measurement unit, although additional sensors or measurement units may be desirable in other examples. The circuits of this disclosure my utilize detailed target models matching to a certain product requirement or criterion. The target may be applied to a combination of measured parameters. i.e., one target and many parameters. A direct comparison with an explicit requirement can be more accurate than a comparison of input parameters with artificial input parameter targets. In some examples, the techniques of this disclosure may include calculation of a safety base failure rate and possibly safety metric values that can be useful for safety related circuit applications. In some examples, the described techniques can provide a maintenance message to initiate device replacement or maintenance actions on one or more circuits due to identified aging effects.

Also, tracking of operating conditions like voltage, frequency, and junction temperature over time can be used. Moreover, the transmission of maintenance messages that predict the loss of function before such loss of function occurs, and initiating device replacement or maintenance action can be performed. Methods of evaluation of safety parameters, like Base failure rates and safety metrics, are also described herein. Moreover maintenance decisions based on a resulting predicted lifetime or predicted safety parameter can be performed according to this disclosure.

According to this disclosure, devices, systems and methods for predicting the future loss of device function are described, which may use time dependent measurements of one or more operation parameters, determining a predicted parameter profile, calculating predicted loss of function, such as violation of safety metrics or reliability lifetime, and initiating maintenance messages to the system.

One or more aspects of this disclosure may include
1. Generalized lifetime may be used to determine loss of function instead of a reliability lifetime only. For example, excessive failure rates determined by intrinsic faults may be used to determine that an end of life is near according to the failure rate curve shown in FIG. 7. This can allow a system or device to predict loss of function in a general way.
2. Local resolved Measurement of parameters can be used.
3. Measurement of activity using counter registers inserted into the circuit may be used. Connection of registers may be defined by a dedicated activity readout scan chain.
4. Generalized Lifetime evaluation principle using predicted parameter profiles may be used. 5. A method to determine predicted parameter profiles (PPP) can be used, as well as properties of PPP.
6. An evaluation method for PPP may be used to precisely determine remaining generalized lifetime.
7. Application of PPP method can be used to determine Base Failure Rate.
8. Application of PPP method to determine FMEDA failure rates and PMHF metrics can be performed.
9. Chip embedded evaluations with simplified formulas can be performed.
10. Simplification of formulas by pre-calculation of mathematical terms of the formulas can be performed, and storing pre-calculated term values as constants can be used to simplify calculations by a circuit in real-time.

Some example measurement processes are now discussed. Multiple parameters can be measured locally and in a time-dependent manner. The following three parameters are given as examples:
1. Temperature−Die+Ambient
2. Processing Load=Activity
3. Frequency
   The techniques of this disclosure may be performed using either embedded or external component (e.g., embedded or external sensors, or measurement units). Semiconductor circuits with embedded internal measurement capabilities may be advantageous for high local resolution and simplicity of measurement for a user. The embedded measurements may be performed in a valid parameter operation range of the measurement circuitry. In contrast, semiconductor circuits with external measurement capabilities may have advantages of possibility measuring a wider parameter range of maximum ratings of a given circuit.

Temperature measurements are now discussed, which may be used in accordance with this disclosure. In some examples, it may be desirable to determine a time dependent product temperature profile and to use the profile to calculate an industry standard base failure rate. Time dependent Temperature profiles can be used to estimate the real product Temperature and Cycling mission profiles according to IEC 62380/ISO 26262:2018-11. This, in turn, can facilitate calculation of an individual product Base Failure. Such calculations are described below as examples of evaluation of measured data.

In some examples, temperature can define a more global parameter, meaning that percent variations across die are smaller and less local separated temperature measurement units may be required. In general, a flexible local resolution can be used. Temperature measurement units can measure local die junction temperature Tj x.

Moreover, temperature measurement units can be implemented as thermal sensors e.g., positive temperature coefficient (PTC) sensor, negative temperature coefficient sensor (NTC), or Bandgap reference temperature sensor.

A local die temperature Tj x associated with a circuit may be general a function of ambient temperature (T_{ambient}), power dissipation (P), and thermal resistance (Rth). Power dissipation (P) may be a function of load capacity (C), activity/frequency (f), Voltage (V_{dd}) and static currents such as leakage currents or a mean value of current (Iₗₑₐₖ, Iₘₑₐₙ)

P=P_{dynamic}+P_{static}+P_{switching} (EQ1)

P=C f V_{dd}²+IₗₑₐₖV_{dd}+IₘₑₐₙV_{dd} (EQ2)

The product junction temperature Tⱼ may be given by

Tⱼ=T_{ambient}+RₜₕP (EQ3)

By electrical switching off a circuit or device, the power consumption P can be reduced to zero. Activating the measurement unit TMx for a very short time only leads to a negligible small average power consumption P. By this approach the ambient temperature Tambient of the product can be measured. Similarly a very small value of Rth allows to measure the ambient temperature.

In general Tj can be locally different depending on local power dissipation P_{local} and local circuit activity/frequency. Circuit activity/frequency (f) may be related to the application and possibly to software or firmware that is in operation in the circuit. Examples of measurement of activity are discussed below.

In some examples, temperature sensors (such as temperature units 202, 204, 206) may be configured to measure both a local die temperature associated with a circuit and ambient temperature around the circuit, e.g., possibly using switchable power domains. With regard to activity measurements by activity monitor 208 or event counters 54A, 54B, 54C, in some cases, activity is dependent on the specific application and possibly software or firmware operating on a circuit function unit. Activity may change between 0% and 100% locally and time dependent. Hence are detailed local resolution may be desirable, depending on the circuit and application of the circuit, for predicting a remaining lifetime of the circuit. A flexible local resolution of circuit activity may be especially desirable for quantifying parameter Activity.

In some examples, the circuit shown in FIG. 5 may facilitate measurement of local switching activity of a circuit function unit 52. Event counters 54A, 54B, 54C may comprise counter registers (e.g., flip-flops) connected as scan chain. As shown in FIG. 5, event counters 54A, 54B, 54C may be positioned in a circuit for activity measurement of activity associated with circuit function unit 52. In some cases, event counters 54A, 54B, 54C may measure the local activity of logic nodes of circuit function unit 52 as well as local clock frequency associated with circuit function unit 52. Registers for each of event counters 54A, 54B, 54C may be connected in a dedicated activity readout scan chain. This may allow for fast efficient readout of activity values associated with each of event counters 54A, 54B, 54C by lifetime modeler 56.

In some examples, event counters 54A, 54B, 54C may provide three different local activity parameter profiles (CNT1 to CNT3) and a clock activity profile (CNTCLK) associated with circuit function unit 52. These local activity parameter profiles clock activity profile may be combined or used collectively to define an activity parameter profile of circuit function unit 52, which can be extrapolated as described herein to create a predictive parameter profile of circuit function unit 52. The predictive parameter profile of circuit function unit 52 (e.g., similar to profile 70 of FIG. 7 but including data for a plurality of event counters 54A, 54B, 54C and a clock activity profile) may then be used for end-of-life prediction analysis.

In some examples, frequency monitor 210 of the circuit shown in FIG. m2 may be used to perform one or more frequency measurements. Frequency of one or more circuit operations or events may also be dependent on the specific type of application possibly software or firmware operating on a circuit function unit. Depending on the type of circuit function unit that is being monitored, different frequency domains may exist. Moreover, the frequency of domains can be locally gated and modified. The local resolution of frequency may depend on the type of circuit and frequency controlling application.

In some examples, measured parameters may be recorded (e.g., in lifetime modeler 220 or lifetime modeler 56) as step functions with a selectable timestep resolution. The recorded values within each timestep may correspond to the average measured value over that time interval. Recording of other values like maximum measured value or median measured values is also possible, as is recording specific events, such as measured values that satisfy a threshold value.

In some examples, lifetime modeler 220 or lifetime modeler 56 may executed evaluation methods as internal “online” chip embedded steps. In other examples, evaluation methods may be performed as external system-level processes or “offline” approaches.

In some examples, chip embedded evaluation calculation can be implemented in lifetime modeler 220 or lifetime modeler 56, for example, via an embedded processor with memory using firmware code or as an embedded state machine and lookup table memory. One advantage of chip embedded evaluation is the simplicity for the user.

In some examples, calculations of a lifetime evaluation process may be simplified by pre-calculation of some or all mathematical terms formulas. The pre-calculated term values can be stored as constants and may be beneficial for acceleration of calculation, by efficiently reducing calculation loads otherwise needed by an embedded processor.

In some examples, the techniques performed according to this disclosure may be used to effectively predict a likely future “Loss of function” of a circuit function unit or a likely future violation of a certain criterion. Three examples for criteria may include:
1) Lifetime
2) Base Failure Rate
3) Probabilistic Metric of Hardware Failures (PMHF)

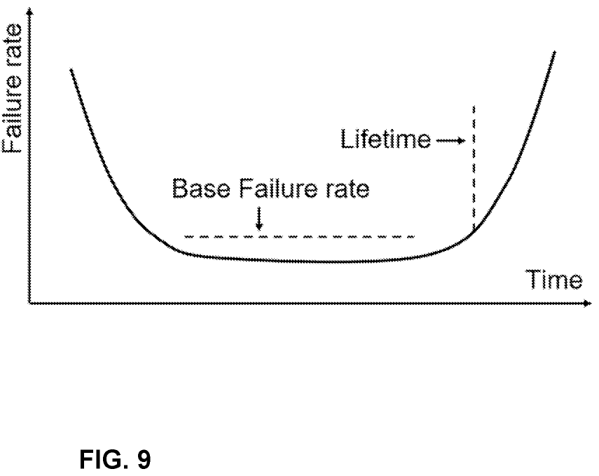

FIG. 9 is a graph showing typical circuit failure rates as a function of time. In some examples, a graph similar to that of FIG. 9 (or parameters or values therein) can be used by lifetime modeler 220 or lifetime modeler 56 for evaluation of a circuit function unit. The curve of FIG. 9 can be viewed as a bathtub-shaped curve, although other generalized criteria not related to bathtub curve parameters can also be used. With the curve shown in FIG. 9, the lifetime of a circuit may be defined by the “lifetime line” shown in FIG. 9 at the right-hand side, wherein there a specifically defined increase (or defined acceleration) in the failure rate predicted by the bathtub curve. A base failure rate line is also illustrated in FIG. 9, which may be defined and used for evaluation of a circuit function unit. In other examples, the base failure rate line illustrated in FIG. 9 may be used in determining a PMHF.

In some examples, lifetime modeler 220 or lifetime modeler 56 may execute one or more generalized lifetime evaluation processes using time dependent parameter profiles. The Generalized Lifetime evaluation process may be performed to determine a conventional lifetime (e.g., a remaining time until the curve of FIG. 9 predicts excessive failure rate by intrinsic faults, such as defined by the “lifetime” line illustrated in FIG. 9). For this purpose, in some examples, a remaining available predicted lifetime (APL) may be determined by lifetime modeler 220 or lifetime modeler 56. Although so-called predicted parameter profiles are discussed, techniques may be extended to apply to other criteria, rather than an estimated lifetime.

In some situations, general circuit functionality is overqualified for a given estimated lifetime, which may help assure circuit component qualification for example according to standards like the Automotive Electronics Council (AEC) Q100 standard. A qualified lifetime may only be valid within a defined range of application profiles (e.g., within a given mission profile). The Qualified lifetime is typically less or equal than the full usable Lifetime.

In some examples, a lifetime circuit model unit 18, 28, 50 may be configured to adapt test conditions based on the Mission Profile, which may be defined according to the AEC Q100 standard. FIG. 6 shows one example of a measured profile 60, which may comprise a time-dependent parameter profile of a circuit function unit. Parameter Profiles like parameter profile 60 of FIG. 6 may be defined by the time dependent application parameters like processing loads and ambient temperatures. All parameters may be required to stay within the product defined maximum ratings. The usable lifetime of a circuit, and hence possible qualified lifetime of an associated product may be dependent on the application Mission profiles.

One approach, according to this disclosure, may include the determination one or more mission profiles based on measured time dependent parameter profiles and one or more correlated profiles with usable lifetime and lifetime qualification results. Using a predicted mission profiles (like predicted profile 70 of FIG. 7) can allow lifetime circuit model unit 18, 28, 50 to determine an “available predicted Lifetime” (APL) can be determined.

Predicted profile 70, in some examples, may comprise a predicated parameter profile (PPP), where a ratio of time shares of a given parameter value in relation to profile duration is identical for measured profile 60 and predicted profile 70.

For example a given value in measured profile 60 may comprise a fraction (Fr) of the entire mission profile 60. Similarly, that value and the extrapolation of that value over other time periods may collectively define that same fraction (Fr) of data within predicted parameter profile 70.

In some examples, a lifetime circuit model unit 18, 28, 50 may be configured to combine equal portions of parameter profile 60 with duration m shown in FIG. 6 to form the predicted profile 70 of duration p as depicted in FIG. 7. As another example, in some cases the predicted profile timeframe between time m and time p can be split into arbitrary time slices with certain parameter values, where ratio of time slices of a given parameter value in relation to profile duration is identical for the measured profile and the predicted profile.

In some examples, a lifetime circuit model unit 18, 28, 50 may be configured to split the predicted profile timeframe between time m and time p into an equal number of time slices as the measured profile (MPP). In this example, every time slice of a predicted profile may have the same parameter value as in the corresponding MPP time slice.

Predicted profile 70, in some examples, may comprise a PPP, where a ratio of a total number of steps at a certain height or magnitude to the total number of steps is identical for measured profile 60 and predicted profile 70. For example, if the ratio of number of steps with height=4 on total number of steps within prefile 60 is 1/14 then this ratio may be the same for predicted profile 70. Furthermore, Predicted profile 70, in some examples, may comprise a PPP, where different local sequence of parameter values are identical to those of measured profile 60.

In some examples, lifetime circuit model unit 18, 28, 50 may perform an evaluation method on a generated PPP to precisely determine remaining generalized lifetime. The methods performed by lifetime circuit model unit 18, 28, 50 may determine multiple predicted parameter profiles (PPP) with different durations. One of the PPPs may define the maximum required duration. If the PPP with maximum duration still fulfils the generalized lifetime criterion then lifetime circuit model unit 18, 28, 50 may determine that a predictive maintenance action is not required during the maximum duration. However, if the criterion is violated for one parameter profile with a given duration (Time A) but not violated for a different (i.e., shorter) duration (Time B), then the generalized lifetime may be between (Time A) and (Time B). The method described above can be performed with arbitrary time resolution, it may be possible for lifetime circuit model unit 18, 28, 50 to determine the generalized lifetime with high precision.

In addition to determination of conventional lifetime of a circuit, the described techniques can be applied to other criteria with the need for preventive maintenance. For example, lifetime circuit model unit 18, 28, 50 may perform reliability evaluation using Industry Standard Base Failure calculations. In particular, industry standards like IEC 62380/ISO 26262:2018-11 can be used by lifetime circuit model unit 18, 28, 50 for on-chip failure rate reliability prediction purpose. Targets for the failure rate can be used can be used as criteria to initiate preventive maintenance messages output from lifetime circuit model unit 18, 28, 50 to another system component, such as a system-level controller or microprocessor. The “predicted Profile” such as predicted profile 40 or 70 can be used to calculate a predicted failure rate.

Industry standards like IEC 62380/ISO 26262:2018-11 may address intrinsic failures. However, the wear out period may be assumed to be far removed from the period of use. According to such standards, the end-of-life period of an integrated circuit is supposed to appear far beyond the utilization period of the equipment. The techniques of this disclosure may, in some cases, extend circuit life beyond that supported by standards like IEC 62380/ISO 26262:2018-11, by facilitating actual circuit life determinations.

In some examples, failure mechanisms assessed by lifetime circuit model unit 18, 28, 50 may include the following for silicon-based circuit technologies:
electromigration;
oxides aging;
hot electrons;
charge gain and charge (for the write-erase cycles of the various programmable memories).

Time dependent temperature profiles, e.g., as described with reference to FIGS. 3 and 4, may be used by lifetime circuit model unit 18, 28, 50 to estimate the real product Temperature and Cycling mission profiles according to IEC 62380/ISO 26262:2018-11. This in turn allows lifetime circuit model unit 18, 28, 50 to calculate an individual product Base Failure (BFR). The usage of other profiles and other Base failure rate models and standards is also possible.

A temperature dependent model may be viewed as a special case of other possible reliability models, which may further include information on circuit activity, frequency, voltages, or other factors. According to IEC 62380 model, a utilization factor may be considered for non-intrinsic failures due to electrical environment of the active component. In this case, the electrical environment may be identified by lifetime circuit model unit 18, 28, 50 with activity, frequency and voltages.

In some examples, lifetime circuit model unit 18, 28, 50 may compare base failure rate results with base failure rate target values. The target value may reflect a certain degree of lifetime consumption. Based on the comparison result a Lifetime message can be output from lifetime circuit model unit 18, 28, 50 to signal the remaining circuit lifetime to a system-level component.

In some examples, lifetime circuit model unit 18, 28, 50 may calculate a failure rate (Lambda) according to the IEC 62380 standard/ISO 26262:2018-11, using the reliability model defined in the standard. In this case, lifetime circuit model unit 18, 28, 50 may apply the mathematic model shown Table 1, as well as one or more additional equations of the IEC 62380 standard for temperature factors or influence factors.

TABLE 1
MATHEMATICAL MODEL:
$λ = ( \frac{\{ {λ}_{1} \times N \times {e}^{- 0.35 \times α} + {λ}_{2} \} \times \{ \frac{{\sum }_{i = 1}^{y} {( {π}_{i} )}_{i} \times {τ}_{i}}{{τ}_{on} + {τ}_{off}} \}}{\text{?}} + \{ \frac{2.75 \times {10}^{- 3} \times {π}_{α} \times ( {\sum }_{i = 1}^{z} {( {π}_{n} )}_{i} \times {( Δ {T}_{i} )}^{0.68} ) \times {λ}_{3}}{\text{?}} \} + \{ \frac{{π}_{i} \times {λ}_{EOS}}{\text{?}} \} ) \times {10}^{- 9} / h$
NECESSARY INFORMATION:
(t_{sc})ᵢ: average outside ambient temperature surrounding the equipment, during the i^{th} phase of the mission profile.
(t_{sc})ᵢ: average ambient temperature of the printed circuit board (PCB) near the components, where the temperature
gradient is cancelled.
λ₁: per transistor base failure rate of the integrated circuit family. See Table 16.
λ₂: failure rate related to the technology mastering of the integrated circuit. See Table 16.
N: number of transistors of the integrated circuit.
a: [(year of manufacturing) - 1998]
(πᵢ)ᵢ: i^{th} temperature factor related to the i^{th} junction temperature of the integrated circuit mission profile.
τᵢ: i^{th} working time ratio of the integrated circuit for the i^{th} junction temperature of the mission profile.
${τ}_{on} : total working time ratio of the integrated circuit . With : {τ}_{on} = {\sum }_{i = 1}^{y} {τ}_{i}$
τ_{off}: time ratio for the integrated circuit being in storage (or dormant). With τₒₙ + τ_{off} = 1
π_{α}: influence factor related to the thermal expansion coefficients difference, between the mounting substrate and the
package material.
(πₙ)ᵢ: i^{th} influence factor related to the annual cycles number of thermal variations seen by the package, with the
amplitude ΔTᵢ.
ΔTᵢ: i^{th} thermal amplitude variation of the mission profile.
λ₃: base failure rate of the integrated circuit package. See Table 17a and 17b
πᵢ: influence factor related to the use of the integrated circuit (interface or not).
λ_{EOS}: failure rate related to the electrical overstress in the considered application.
$\text{?} \text{indicates text missing or illegible when filed}$

In some examples, lifetime circuit model unit 18, 28, 50 may receive input parameters of the model that include temperature measurements and times. In some examples, lifetime circuit model unit 18, 28, 50 may receive input parameters for each operation or phase of a circuit (which may be die related parameter). Input parameters determined by die related temperature mission profile and junction temperature profile may include such things as:
Average ambient temperature of printed circuit board t_{aci} in the ith operating phase [° C.]
Junction temperature t_{j_i} in the ith operating phase [° C.]
The total expected lifetime of the circuit
The time ratio τᵢ of the ith operating phase
   These values may be used to determine various values of Table 1, including for example: (πₜ)ᵢ, τᵢ, τₒₙ, τ_{off}.

In some examples, lifetime circuit model unit 18, 28, 50 may calculate or determine a junction temperature t_{j_i} associated with a main function unit from self-heating.

t_{j_i}=t_{aci}+Self heating (EQ4)

Self-heating in turn can be derived from power dissipation P and thermal resistance Rth

Self-heating=RₜₕP (EQ5)

In some examples, lifetime circuit model unit 18, 28, 50 may receive measured input parameters per cycling phase of a circuit (which may be package related). In this case, for example, additional input parameters may include:
Average outside ambient temperature (tₐₑ)ᵢ surrounding the equipment in the ith operating phase [° C.]
(tac)i: average ambient temperature of the printed circuit board (PCB) near the components, where the temperature gradient is cancelled.
Number of cycles in the jₜₕ phase per year
self heating in the jₜₕ cycle phase (e.g., yes or no).
   These parameters may be used to determine various values of Table 1, including for example: (πₙ)ᵢ, ΔTᵢ

In some examples, any remaining calculation input parameters used by lifetime circuit model unit 18, 28, 50 according to Table 1, besides year of manufacturing “a” may be fixed values for the product. The production year “a” can be set to fixed value also with “a” is equal to the first year of product fabrication by applying a conservative estimation.

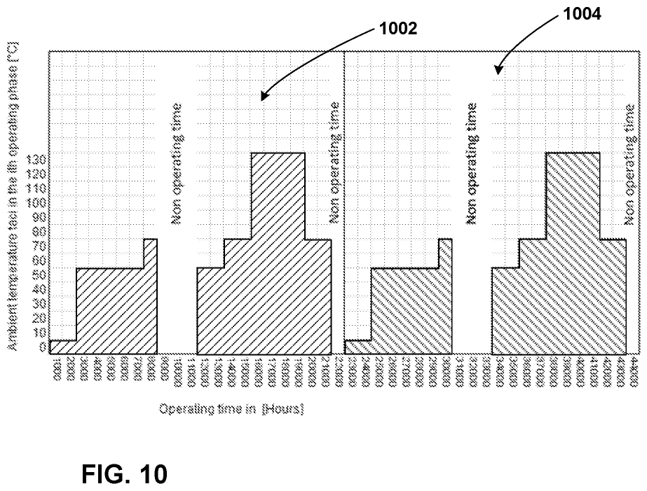

Lifetime circuit model unit 18, 28, 50 may preform one or more calculations of failure rates. Moreover, in some cases, parameter profiles may account for non-operating time of a circuit. Consider, for example, the parameter profile shown in FIG. 10, which includes measured parameter 1002 and an extrapolation 1004 of the measured parameters. In this case, both measured parameter 1002 and an extrapolation 1004 of the measured parameters include non-operating time. The reliability model of IEC 62380/ISO 26262:2018-11 may predict a time independent failure rate. An input parameter to the model may assume a usable lifetime or (Total Lifetime) as a fixed value. In one example usable lifetime or (Total Lifetime) may be approximately 44000 hours (equal to about 5 years). The Parameter Profile diagram of FIG. 10 depicts the ambient temperature versus the operating time.

In the following Example 1 below includes Tables 2-6 show some example Customer Temperature Profiles that can be applied while the cycling mission profile is kept constant (e.g., for a Motor Control Cycling Profile).

### Example 1

TABLE 2
Environmental information

| | |
|---|---|
| Year of manufacturing [YYYY] | 2020 |
| Self heating [° C.] | 10 |
| Total Life Time [Years] | 5.02283105 |

TABLE 3
Settings for package and substrate/calculation
instructions/Mission Profiles

| | |
|---|---|
| Package | PG-WFWLB-152-1 |
| Substrate material | Epoxy Glass (FR4, G-10) |
| Interpretation for λ₂ | Weighted Average |
| Interpretation for (πₜ)ᵢ × τᵢ | Weighted Average |
| Selected Temperature Mission Profile | Customer Temperature Profile |
| Selected Cycling Phases Mission Profile | Motor Control |

TABLE 4
Bipolar and MOS circuits (BICMOS)

| | | |
|---|---|---|
| | Digital circuits | 10,000 transistors |
| | Linear/digital circuits low voltage (<6 V) | 5,000 transistors |
| | Linear/digital circuits, high voltage (≥6 V) | |
| | and Smart Power | |
| SRAM | Static Read Access Memory | |

TABLE 5A

| | Working | Working | Working | Working |
|---|---|---|---|---|
| Optional: Customer | rate | rate | rate | rate |
| Temperature Profile | phase 1 | phase 2 | phase 3 | phase 4 |
| Ambient temperature t_{aci} | 0.0 | 50.0 | 70.0 | 120.0 |
| in the iₜₕ operating phase | | | | |
| [° C.] | | | | |
| Operating time in the iₜₕ | 2000 | 5000 | 4000 | 3000 |
| phase [Hours] | | | | |

TABLE 5B

| | Working | Working | Working | Working |
|---|---|---|---|---|
| Optional: Customer | rate | rate | rate | rate |
| Temperature Profile | phase 5 | phase 6 | phase 7 | phase 8 |
| Ambient temperature t_{aci} | 0.0 | 50.0 | 70.0 | 120.0 |
| in the iₜₕ operating phase | | | | |
| [° C.] | | | | |
| Operating time in the iₜₕ | 2000 | 5000 | 4000 | 3000 |
| phase [Hours] | | | | |

TABLE 6

| | | Bipolar and |
|---|---|---|
| Base Failure Rate calculation according | | MOS circuits |
| to ISO26262-11: 2018 4.6.2.1.1 | | (BICMOS) |
| Applied Temperature Mission Profile: | λ_{DIE} | 12.88 FIT |
| ‘Customer Temperature Profile’ and | λ_{PACKAGE} | 66.79 FIT |
| Cycling Phases Mission Profile: | Sum λ_{DIE} and | 79.67IT |
| ‘Motor Control’ | λ_{PACKAGE} | |

In example 1, the result of the calculation for qualification profile is a die failure rate of 12.88 FIT and package failure rate of 66.79 FIT. The package failure rate does not change when cycling profile is constant. To illustrate the usage of predicted parameter profiles two PPPs may be considered by lifetime circuit model unit 18, 28, 50. A predicted parameter profile “PPP3 short” may be based on a short measurement period and a predicted parameter profile “PPP3 long” may be based on a longer measurement.

The second parameter profile “PPP3 long” may be based on a longer measurement than predicted parameter profile “PPP3 short”. The measured portion of the profile until 22000 h may contain more demanding temperatures, some examples. FIG. 10 is a graph showing a extrapolation of the temperature measurements and non-operating time to create a predicted profile of a circuit that accounts for operating time and non-operating time of the circuit. Within FIG. 10, measured parameter 1002 includes a predicted parameter profile “PPP3 short” corresponding to the first 11000 hours and second parameter profile “PPP3 long” corresponding to the first 22000 hours associated with the entire measured parameter 1002.

In some examples, lifetime circuit model unit 18, 28, 50 may compare the die failure rate results of the qualified profile with the two predicted profiles PPP3 short and PPP3 long. The result of PPP3 short calculation is a die failure rate of 5.92 FIT while the result of PPP3 long calculation is a die failure rate of 19.39 FIT. The die failure rate results are summarized in the table 7.

TABLE 7

| | Measured Time | Die Failure Rate | |
|---|---|---|---|
| Profile | [hours] | [FIT] | Comment |
| Qualification | N.A. | 12.88 | |
| Profile | | | |
| PPP3 short | 11000 | 5.92 | Predicted Profile |
| | | | based on short |
| | | | measurement |
| PPP3 long | 22000 | 19.39 | Predicted Profile |
| | | | based on longer |
| | | | measurement |

In the Example summarized in FIG. 7, the failure rate results of demanding Profile PPP3 long is substantial higher than the failure rate of Profile PPP3 short and also higher than the failure rate belonging to qualification profile. Both PPP3 profiles belong to the same measurement activity with progressing time and therefore share an identical beginning phase.

Taking the failure rate value of the qualification profile as a target the predicted profile failure rates can be compared with the target. Moreover the predicted failure rate crosses the target value during the progressing measurement at a time between 11000 and 22000 hours. This crossing can be used as a trigger to initiate a message to system. In other words a message can be initiated by lifetime circuit model unit 18, 28, 50 whenever the predicted value is above the target value.

In some examples, lifetime circuit model unit 18, 28, 50 may be configured to perform safety parameter evaluation using a FMEDA calculation. The failure rate and predicted failure rate described above may be identical to an individual product hard error (HE) base failure rate (HE_BFR) according to ISO 26262 [ISO 26262:2018]. This in turn can be used to calculate selected FMEDA results like probabilistic metric for hardware failures (PMHF) or result failure rates. The calculated results based on the predicted Mission profile can be compared with targets for metric or failure rates. Depending on the result of the comparison a preventive maintenance message can initiated by lifetime circuit model unit 18, 28, 50 and transmitted to another component of a larger system.

The FMEDA calculation can be implemented by lifetime circuit model unit 18, 28, 50 as an “embedded Micro FMEDA.” FMEDA hard error failure rates are typically pure linear function of HE base failure rates BFR therefore easy to implement using simple equations and constant parameters.

HE failure rate₁=a₁*HE_BFR (EQ6)

PMHF may also be a result of simple adding and multiplication of Failure rates with Lifetime. For example, PMHF can be expressed as:

(PMHF according to ISO 26262 Part 5)

PMHF=b₁*HE_BFR+SE₁+[(HE_BFR*b₂)+SE₂]*[(HE_BFR*b₃)*Tlife+(SE₃)*TDC] (EQ7)

with constants

b₁, b₂, b₃, SE₁, SE₂, SE₃, Tlife, TDC

In some cases, the calculations by lifetime circuit model unit 18, 28, 50 can be further simplified to the following quadratic equation:

(PMHF according to ISO 26262 Part 5):

PMHF=HE_BFR²*b₂₃*Tlife+HE_BFR*(SE₂b₃*Tlife+b₁)+(SE₃)*TDC+SE₁ (EQ8)

And:

PMHF=HE_BFR²*x+HE_BFR*y+z (EQ9)

with constants independent from HE base failure rate: x,y,z

In some examples, PMHF can also be expressed as:

(PMHF according to ISO 26262 Part 10 V2)

PMHF=b₁*HE_BFR+SE₁+b₂*HE_BFR²*TDC+b₃*HE_BFR×SE₂×TDC+SE₃²*TDC+b₄*HE_BRF²*Tlife+b₅*HE_BFR×SE₄*Tlife (EQ10)

With constants

b₁, b₂, b₃, b₄, SE₁, SE₂, SE₃, SE₄, Tlife, TDC

PMHF expression be further simplified to the following quadratic equation:

(PMHF according to ISO 26262 Part 10 V2)=HE_BFR²*(b₂*TDC+b₄*Tlife)+HE_BFR*(b₁+b₃×SE₂×TDC+b₅×SE₄*Tlife)+SE₃²*TDC+SE₁

Respectively:

PMHF=HE_BFR²*x+HE_BFR*y+z (EQ12)

with constants independent from HE base failure rate: x,y,z.

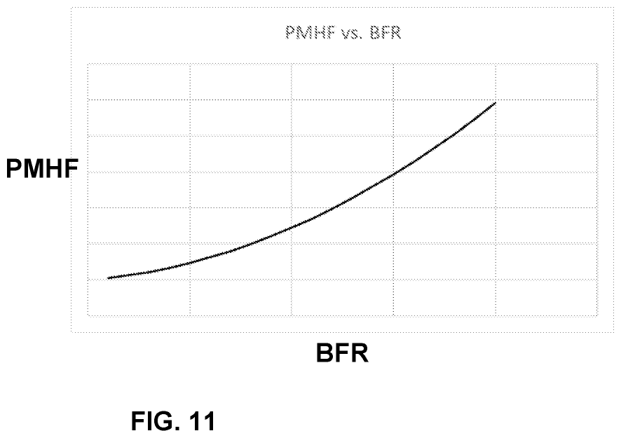

In some examples, the implementation of PMHF in form of equation (EQ12) is very efficient. It can be noted that equation 12 (EQ12) has the same form as equation 9 (EQ9). In the example of an increasing base failure rate (BFR) the resulting PMHF looks as shown in FIG. 11. In particular, FIG. 11 is a basic graph showing an example relationship between base failure rate (BFR) of a circuit and probabilistic metric for hardware failures (PMHF), e.g., in accordance with the International Organization for Standardization (ISO) standard 26262 related to functional safety in road vehicles and the examples above.

In some examples, the PMHF formulas used by lifetime circuit model unit 18, 28, 50 are based on ISO 26262 and consistent with PMHF according to ISO 26262 Part 5, as follows:

PMHF=SPF,HE+SPF,SE+RF,HE+RF,SE+[(IF,DPFdet,HE+SM1,DPFdet,HE)+(IF,DPFdet,SE+SM1,DPFdet,SE)]×[(IF,DPFlat,HE+SM,DPFlat,HE)×Tlifetime+(IF,DPFlat,SE+SM,DPFlat,SE)×TDC]

Also, in some examples, PMHF may be defined by lifetime circuit model unit 18, 28, 50 according to ISO 26262 Part 10 V2 as follows:

$$PMHF = λ SPF , HE + λ SPF , SE + λ RF , HE + λ RF , SE + 0.5 \times [ + λ SM 1 , DPF , det \times λ IF , DPF \times TDC + λ SM 1 , DPF , lat , HE \times λ IF , DPF \times Tlifetime + λ SM 1 , DPF , lat , SE \times λ IF , DPF \times TDC + λ IF , DPF , lat , HE \times λ SM 1 , DPF \times Tlifetime + λ IF , DPF , lat , SE \times λ SM 1 , DPF \times TDC ]$$

As mentioned, it may also be desirable, in some situations, for lifetime circuit model unit 18, 28, 50 to issue alerts, faults, lifetime predictions, or other signals to one or more system-level components, such as a microprocessor, a microcontroller, an electronic control unit (ECU), or other system level device. In some examples, a message from lifetime circuit model unit 18, 28, 50 to the system is based on the above determined criteria and prediction of generalized lifetime.

In some examples, a reliability lifetime evaluation is preformed by lifetime circuit model unit 18, 28, 50 to determine a remaining available predicted Lifetime (APL) of a functional circuit. In some examples, the remaining available predicted Lifetime (APL) is transmitted to the system either by polling or by regular transmission. In some examples, the APL is compared to available qualified lifetime AQL=(Qualified lifetime−current lifetime) by lifetime circuit model unit 18, 28, 50, and lifetime circuit model unit 18, 28, 50 may output a maintenance message to system when the APL is less than 90% or 100% of AQL.

Furthermore, in some examples, lifetime circuit model unit 18, 28, 50 may output the predicted base failure rate value to larger system or other system components either by polling or by regular transmission. In still other examples, lifetime circuit model unit 18, 28, 50 may compare the failure rate value of the predicted profile with the target defined by value of the qualification profile. If the predicted value is higher than 90% or 100% of the target a maintenance message to system is triggered by lifetime circuit model unit 18, 28, 50.

In some examples, PMHF or Failure rate may be use to initiate messaging. The predicted metric and failure rate values may be transmitted from lifetime circuit model unit 18, 28, 50 to one or more other system-level components by polling or by regular transmission. In still other examples, the failure rate value of the predicted profile is compared with the target metric and failure rate defined for the product. If the predicted value is higher than 90% or 100% of the target a maintenance message to system is triggered by lifetime circuit model unit 18, 28, 50.

Transmission of one or more end of life messages from lifetime circuit model unit 18, 28, 50 may cause system-level action or response. The maintenance message may be transmitted to the system by an interface associated with any circuit that lifetime circuit model unit 18, 28, 50. For example electrical standard Interfaces like a controller area network (CAN) bus interface; a controller area network-flexible data (CAN-FD) bus interface; a local interconnect network (LIN) bus interface; a bus operating according to a universal asynchronous receiver/transmitter (UART) over CAN; or a controller area network-extra-large (CAN-XL) bus interface, a peripheral sensor interface standard (PSI5) interface, a serial peripheral interface (SPI) or another type of interface. Also, it may be desirable to transmit the message using a defined level change on a signal pin. Other interfaces like optical interfaces could also be used. In some examples, the maintenance message may schedule, recommend or require replacement of the circuit being monitored or a larger device associated with circuit. Another possible action is the activation of a redundant portion of the device. Yet another action is an adaptation of device application and or operating parameters.

In this disclosure, an extrinsic failure mechanism may refer to a failure mechanism caused by an error occurring during the design, layout, fabrication, or assembly process or by a defect in the fabrication or assembly materials, or a failure mechanism that is directly attributable to a defect created during manufacturing. In contrast, an intrinsic failure mechanism may refer to a failure mechanism caused by a natural deterioration in the materials or by the manner in which the materials are combined during fabrication or assembly processes that are within specification limits, or a failure mechanism attributable to natural deterioration of materials processed per specification.

In this disclosure, a generalized lifetime may refer to the product application time until a loss of function with respect to a given criterion occurs. The standard reliability lifetime may be viewed as a special case of General Lifetime.

The following numbered clauses demonstrate one or more aspects of the disclosure.

Clause 1—A circuit comprising: a function unit configured to perform a circuit function; and a lifetime model unit configured to estimate a remaining life of the circuit, wherein the lifetime model unit is configured to: measure one or more circuit parameters over a period of time during operation of the circuit, and estimate the remaining life of the circuit based on the one or more measured circuit parameters over the period of time during operation of the circuit.

Clause 2—The circuit of clause 1, wherein the lifetime model unit is configured to: measure the one or more circuit parameters over a first period of time during operation of the circuit; extrapolate the measured one or more one or more circuit parameters over a second period of time; and estimate the remaining life of the circuit based on the extrapolation of the measured one or more one or more circuit parameters over the second period of time.

Clause 3—The circuit of clause 1 or 2, wherein the one or more measured circuit parameters comprise temperature measurements.

Clause 4—The circuit of any of clauses 1-3, wherein the one or more measured circuit parameters comprise activity metric measurements.

Clause 5—The circuit of clause 4, wherein the activity metric measurements comprise one or more counts of circuit activity.

Clause 6—The circuit of any of clauses 1-5, wherein the lifetime model unit is configured to: measure the one or more circuit parameters in a plurality of different circuit locations over a first period of time; extrapolate the measured one or more one or more circuit parameters in the different circuit locations over a second period of time; and estimate the remaining life of the circuit based on the extrapolation of the measured one or more one or more circuit parameters in the different circuit locations.

Clause 7—The circuit of any of clauses 1-6, wherein the one or more measured circuit parameters comprise frequency measurements.

Clause 8—The circuit of any of clauses 1-7, wherein the one or more measured circuit parameters comprise temperature measurements, activity metric measurements, and frequency measurements.

Clause 9—The circuit of any of clauses 1-8, wherein the lifetime model unit is configured to output an alert in response to identifying that the estimate of the remaining life is less than a threshold.

Clause 10—The circuit of any of clauses 1-9, wherein the lifetime model unit is configured to disable at least a portion of the circuit in response to identifying that the estimate of the remaining life is less than a threshold.

Clause 11—The circuit of any clauses 1-10, wherein the lifetime model unit is configured to disable at least a portion of a larger system associated with the circuit in response to identifying that the estimate of the remaining life is less than a threshold.

Clause 12—The circuit of any of clauses 1-11, wherein the period of time comprises a life of the circuit.

Clause 13—The circuit any of clauses 1-12, wherein function unit comprises one or more circuit units selected from a group consisting of: a load driver circuit; a logic circuit; a motor driver; an oscillator circuit; a level shifter circuit; a phase shift circuit; a phase locked loop circuit; an analog-to-digital converter circuit; a digital-to-analog converter circuit; an ALU; a processor; a microcontroller; a DSP; a communication interface circuit; a digital logic circuit; a state machine; a signal processing circuit; a control circuit; an analog function circuit; a sensor; or a memory circuit.

Clause 14—The circuit any of clauses 1-13, wherein the lifetime model unit comprises at least a portion of the function unit configured to estimate the remaining life during a period of time when the function unit is not performing the circuit function.

Clause 15—A method comprising: performing a circuit function via a circuit; and estimating a remaining life of the circuit, wherein estimating the remaining life of the circuit includes: measuring one or more circuit parameters over a period of time during operation of the circuit, and estimating the remaining life of the circuit based on the one or more measured circuit parameters over the period of time during operation of the circuit.

Clause 16—The method of clause 15, wherein estimating the remaining life of the circuit comprises: measuring the one or more circuit parameters over a first period of time during operation of the circuit; extrapolating the measured one or more circuit parameters over a second period of time; and estimating the remaining life of the circuit based on the extrapolation of the measured one or more one or more circuit parameters over the second period of time.

Clause 17—The method of clause 15 or 16, wherein estimating the remaining life includes calculating a base failure rate.

Clause 18—The method of any of clauses 15-17, wherein estimating the remaining life further includes performing a failure mode effect and diagnostic analysis.

Clause 19—The method of any of clauses 15-18, wherein the one or more measured circuit parameters comprise one or more measurements selected from a group consisting of: temperature measurements; activity metric measurements; one or more counts of a measured circuit activity; or frequency measurements.

Clause 20—The method of any of clauses 15-19, further comprising: outputting an alert in response to identifying that the estimate of the remaining life is less than a threshold.

Clause 21—The method of any of clauses 15-20, further comprising: disabling at least a portion of the circuit in response to identifying that the estimate of the remaining life is less than a threshold.

Clause 22—The method of any of clauses 15-21, wherein the period of time comprises a life of the circuit.

Clause 23—The method of any of clauses 15-22, wherein performing the circuit function comprises performing one or more functions of one or more circuits selected from a group consisting of: a load driver circuit; a logic circuit; a motor driver; an oscillator circuit; a level shifter circuit; a phase shift circuit; a phase locked loop circuit; an analog-to-digital converter circuit; a digital-to-analog converter circuit; an ALU; a processor; a microcontroller; a DSP; a communication interface circuit; a digital logic circuit; a state machine; a signal processing circuit; a control circuit; an analog function circuit; a sensor; or a memory circuit.

Various examples of the disclosure have been described. Any combination of the described systems, operations, or functions is contemplated. These and other examples are within the scope of the following claims.

What is claimed is:

1. A circuit comprising:
a function unit configured to perform a circuit function; and
a lifetime model unit configured to estimate a remaining life of the circuit, wherein the lifetime model unit is configured to:
measure one or more circuit parameters over a period of time during operation of the circuit, and
estimate the remaining life of the circuit based on the one or more measured circuit parameters over the period of time during operation of the circuit.

2. The circuit of claim 1, wherein the lifetime model unit is configured to:
measure the one or more circuit parameters over a first period of time during operation of the circuit;
extrapolate the measured one or more one or more circuit parameters over a second period of time; and
estimate the remaining life of the circuit based on the extrapolation of the measured one or more one or more circuit parameters over the second period of time.

3. The circuit of claim 1, wherein the one or more measured circuit parameters comprise temperature measurements.

4. The circuit of claim 1, wherein the one or more measured circuit parameters comprise activity metric measurements.

5. The circuit of claim 4, wherein the activity metric measurements comprise one or more counts of circuit activity.

6. The circuit of claim 1, wherein the lifetime model unit is configured to:
measure the one or more circuit parameters in a plurality of different circuit locations over a first period of time;
extrapolate the measured one or more one or more circuit parameters in the different circuit locations over a second period of time; and
estimate the remaining life of the circuit based on the extrapolation of the measured one or more one or more circuit parameters in the different circuit locations.

7. The circuit of claim 1, wherein the one or more measured circuit parameters comprise frequency measurements.

8. The circuit of claim 1, wherein the one or more measured circuit parameters comprise temperature measurements, activity metric measurements, and frequency measurements.

9. The circuit of claim 1, wherein the lifetime model unit is configured to output an alert in response to identifying that the estimate of the remaining life is less than a threshold.

10. The circuit of claim 1, wherein the lifetime model unit is configured to disable at least a portion of the circuit in response to identifying that the estimate of the remaining life is less than a threshold.

11. The circuit of claim 1, wherein the lifetime model unit is configured to disable at least a portion of a larger system associated with the circuit in response to identifying that the estimate of the remaining life is less than a threshold.

12. The circuit of claim 1, wherein the period of time comprises a life of the circuit.

13. The circuit of claim 1, wherein function unit comprises one or more circuit units selected from a group consisting of:
a load driver circuit;
a logic circuit;
a motor driver;
an oscillator circuit;
a level shifter circuit;
a phase shift circuit;
a phase locked loop circuit;
an analog-to-digital converter circuit;
a digital-to-analog converter circuit;
an arithmetic logic unit (ALU);
a processor;
a microcontroller;
a digital signal processor (DSP);
a communication interface circuit;
a digital logic circuit;
a state machine;
a signal processing circuit;
a control circuit;
an analog function circuit;
a sensor; or
a memory circuit.

14. The circuit of claim 1, wherein the lifetime model unit comprises at least a portion of the function unit configured to estimate the remaining life during a period of time when the function unit is not performing the circuit function.

15. A method comprising:
performing a circuit function via a circuit; and
estimating a remaining life of the circuit, wherein estimating the remaining life of the circuit includes:
measuring one or more circuit parameters over a period of time during operation of the circuit, and
estimating the remaining life of the circuit based on the one or more measured circuit parameters over the period of time during operation of the circuit.

16. The method of claim 15, wherein estimating the remaining life of the circuit comprises:
measuring the one or more circuit parameters over a first period of time during operation of the circuit;
extrapolating the measured one or more circuit parameters over a second period of time; and
estimating the remaining life of the circuit based on the extrapolation of the measured one or more one or more circuit parameters over the second period of time.

17. The method of claim 15, wherein estimating the remaining life includes calculating a base failure rate.

18. The method of claim 15, wherein estimating the remaining life further includes performing a failure mode effect and diagnostic analysis (FMEDA) calculation.

19. The method of claim 15, wherein the one or more measured circuit parameters comprise one or more measurements selected from a group consisting of:
temperature measurements;
activity metric measurements;
one or more counts of a measured circuit activity; or
frequency measurements.

20. The method of claim 15, further comprising:
outputting an alert in response to identifying that the estimate of the remaining life is less than a threshold.

21. The method of claim 15, further comprising:
disabling at least a portion of the circuit in response to identifying that the estimate of the remaining life is less than a threshold.

22. The method of claim 15, wherein the period of time comprises a life of the circuit.

23. The method of claim 15, wherein performing the circuit function comprises performing one or more functions of one or more circuits selected from a group consisting of:
a load driver circuit;
a logic circuit;
a motor driver;
an oscillator circuit;
a level shifter circuit;
a phase shift circuit;
a phase locked loop circuit;
an analog-to-digital converter circuit;
a digital-to-analog converter circuit;
an arithmetic logic unit (ALU);
a processor;
a microcontroller;
a digital signal processor (DSP);
a communication interface circuit;
a digital logic circuit;
a state machine;
a signal processing circuit;
a control circuit;
an analog function circuit;
a sensor; or
a memory circuit.
